(19) United States
(12) Patent Application Publication
(10) Pub. No.: US 2014/0195386 A1
(43) Pub. Date: Jul. 10, 2014

(54) PROCESSING METHOD AND PROCESSING SYSTEM FOR ORDER DATA IN NETWORK PAYMENT SYSTEM

(71) Applicant: TENCENT TECHNOLOGY (SHENZHEN) COMPANY LIMITED, Shenzhen City (CN)

(72) Inventors: SONG-XU WANG, Shenzhen City (CN); HAI LONG, Shenzhen City (CN)

(73) Assignee: TENCENT TECHNOLOGY (SHENZHEN) COMPANY LIMITED, Shenzhen City (CN)

(21) Appl. No.: 14/205,350

(22) Filed: Mar. 11, 2014

Related U.S. Application Data
(63) Continuation of application No. PCT/CN2012/080444, filed on Aug. 22, 2012.

(30) Foreign Application Priority Data
Sep. 19, 2011 (CN) 201110277634.8

(51) Int. Cl. G06Q 30/06; G06Q 20/42

(52) U.S. Cl. CPC G06Q 30/0637; G06Q 20/42
USPC 705/26.82

(57) ABSTRACT

A processing method for order data in a network payment system. The processing method includes: receiving an order instruction issued from a user terminal; generating an order data including a connected user account information according to the order instruction; sending the order data and prompting a confirmation to the user terminal and notifying the user terminal to send the order data to a network bank system in response to a receiving of a confirmation instruction from a user account and thereby configuring the network bank system to verify the order data; and presenting the order data including the connected user account information to the user terminal after the network bank system returning that a corresponding verification result is positive. A processing system for order data in a network payment system is also provided. Thus, the network payment system has higher data security.

### CROSS-REFERENCE TO RELATED APPLICATION

This application is a continuation application of International (PCT) Patent Application No. PCT/CN2012/080444 filed on Aug. 22, 2012, now pending and designating the United States, which also claims benefit of China Patent Application No. 201110277634.8, filed on Sep. 19, 2011. The entirety of the above-mentioned patent applications is hereby incorporated by reference herein and made a part of this specification.

### FIELD OF THE INVENTION

The present invention relates to the field of processing technique for data connected with online order and payment, and more particularly to processing method and processing system for order data in a network payment system.

### BACKGROUND OF THE INVENTION

With the popularity of the network, online payment system is getting more and more popular and users can purchase products through online payment without going out.

Online payment system is a data processing system, and all of the processes and data are controlled and processed by computers or similar data processing devices. Thus, if the payment processes and related data are manipulated or forged by malicious programs (for example, computer trojan, viruses, etc.), connected users may have money lost.

FIG. 1 is a schematic diagram illustrating a conventional online payment process. As shown, the process includes following steps.

In Step 1, a user account browsers product item information in a merchant systems (e.g., a merchant website) and sends an order instruction.

In Step 2, the merchant system generates order data according to a payment interface of a network bank system, performs a signature process on the order data by using an application programming interface (API) of the network bank system and a merchant certification, and returns a web-formatted form to the user terminal (e.g., the browser of the user account); wherein the action address of the form is directed to an application program of the network bank system for receiving order data of merchants.

In Step 3, the user account clicks on a specific button to confirm this order and the user terminal submits the order data to the network bank system.

In Step 4, the network bank system receives the order data and verifies order product item information and merchant information.

In Step 5, the network bank system presents, if the verification result is positive, a payment page thereof and prompts the user account to enter a transaction card number.

In Step 6, after the user account entering the transaction card number, the user terminal submits the transaction card number information to the network bank system.

In Step 7, the network bank system queries the related information of the user account.

In Step 8, the network bank system returns specific pre-saved information of the user account in the bank to the user terminal.

In Step 9, the user account verifies the specific pre-saved information.

In Step 10, the network bank system returns a transaction confirmation page to the user terminal.

In Step 11, the user account performs a transaction confirmation through a respective authentication way (step 11), wherein the authentication way may support static payment password, dynamic password card, certificate signature, etc.

In Step 12, after the verification, the network bank system performs a payment process.

In Step 13, after network bank system processing the payment instruction and if the merchant system requiring a real-time notification from the network bank system, the network bank system posts the processing result in Hypertext Transfer Protocol (HTTP) protocol and submits the notification message data to the merchant system, and the network bank system does not display the transaction results page to the user account until the merchant system returns pickup address or close the connection established by the merchant system and the network bank system.

In Step 14, after processing the payment instruction, the network bank system directly displays the transaction result to the user terminal if the merchant system does not require a real-time notification from the network bank system.

The above-mentioned prior art for the processing of order data has the following disadvantages.

In the related page data displayed by the merchant system or the network bank system for the user account, there is no user account information connected to the order; accordingly, the network bank system is not able to verify the user account information connected to the order. Thus, if malicious programs forge an order instruction in the above process and the forged order instruction is sent to the merchant system, the forged order instruction may forge a user account information and the merchant system may generate order data for the user account according to the forged order instruction. Because user account information connected to this order will not be presented to the user account in the whole process and the process is directed to the web-page of the network bank system in Step 4, the information of the money count associated with the user account may be stolen indirectly due to that the network bank system only verify the order data and the merchant information rather than verifying the connection between the user account and the order. Thus, there exists a security risk in the conventional process for order data.

### SUMMARY OF THE INVENTION

An objective of the present invention is to provide processing method and processing system for order data in a network payment system so as to enhance the data security in the network payment system.

The present invention provides a processing method for order data in a network payment system. The processing method includes steps of: receiving an order instruction issued from a user terminal; generating an order data including a connected user account information according to the order instruction; sending the order data and prompting a confirmation to the user terminal and notifying the user terminal to send the order data to a network bank system in response to a receiving of a confirmation instruction from a user account and thereby configuring the network bank system to verify the order data; and presenting the order data including the connected user account information to the user terminal after the network bank system returning that a corresponding verification result is positive.

The present invention further provides a processing system for order data in a network payment system. The processing system includes an order instruction receiving module, an order data generating module, an order prompting module, a verification module and a presentation module. The order instruction receiving module is disposed in a merchant system and configured to receive an order instruction issued from a user terminal. The order data generating module is disposed in the merchant system and configured to generate an order data including a connected user account information according to the order instruction. The order prompting module is disposed in the merchant system and configured to send the order data and prompt a confirmation to the user terminal and notify the user terminal to send the order data to a network bank system in response to a receiving of a confirmation instruction from the user account. The verification module is disposed in the network bank system and configured to verify the received order data. The presentation module is disposed in the network bank system and configured to, when a verification result obtained by verifying the received order data is positive, present the order data comprising the connected user account information to the user terminal.

Compared with the conventional technique, the present invention has enhanced information connection among merchant system, network bank system and user account as well as improved information presentation of connected to the order by adding the verification and presentation of connected user account information in the process for order data. Thus, even any specified step in this purchasing process is manipulated or forged by malicious programs; the user account can be aware of the issue in the presented information and accordingly stop the payment process timely. Consequentially, the information of the money count associated with the user account is prevented from being stolen indirectly and the data security of the network payment system is increased.

In addition, through initiatively entering the connected user account information by a user account and verifying the connected user account information in a network bank system, the user account can be aware of that the order data may be forged timely and consequentially the network payment system has higher data security.

Moreover, through the cross-verification on the order data between the merchant system and the network bank system, the payment process will automatically stop if the comparison result indicates that the order data may be forged. Thus, the occurrence of the security issue resulted by malicious programs can be prevented fundamentally.

### BRIEF DESCRIPTION OF THE DRAWINGS

In order to describe the embodiments of the present invention more clearly, the accompanying drawings required for describing the embodiments are briefly introduced hereinafter. It is apparent that the accompanying drawings are only used for illustrating some of the embodiments of the present invention, and for those ordinarily skilled in the art, further drawings can be realized without additional inventive efforts:

FIG. 1 is a schematic diagram illustrating a conventional online payment process;

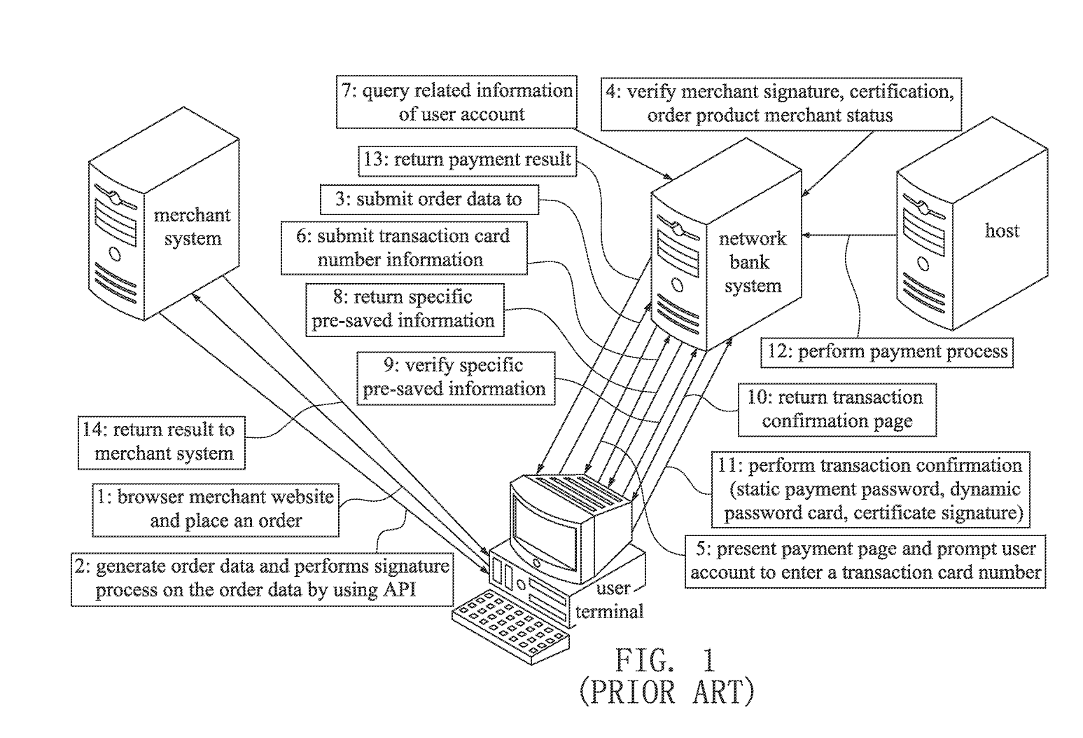

FIG. 2 is a diagram schematically illustrating a processing method for order data in a network payment system in accordance with an embodiment of the present invention;

FIG. 3 is a diagram schematically illustrating a processing method for order data in a network payment system in accordance with another embodiment of the present invention;

FIG. 4 is a diagram schematically illustrating a processing method for order data in a network payment system in accordance with still another embodiment of the present invention;

FIG. 5 is a schematic diagram of a processing system for order data in a network payment system in accordance with an embodiment of the present invention;

FIG. 6 is a schematic diagram of a processing system for order data in a network payment system in accordance with another embodiment of the present invention; and

FIG. 7 is a schematic diagram of a processing system for order data in a network payment system in accordance with still another embodiment of the present invention.

### DETAILED DESCRIPTION OF PREFERRED EMBODIMENTS

Hereinafter, combined with the accompanying drawings of the embodiments of the present invention, the technical solutions of the embodiments of the present invention are clearly and fully described. It is apparent that the embodiments are only some of the embodiments of the present invention other than all the embodiments. Based on the embodiments of the present invention, all the other embodiments derived therefrom without additional inventive efforts of an ordinarily skilled person in the art are included in the scope of the present invention.

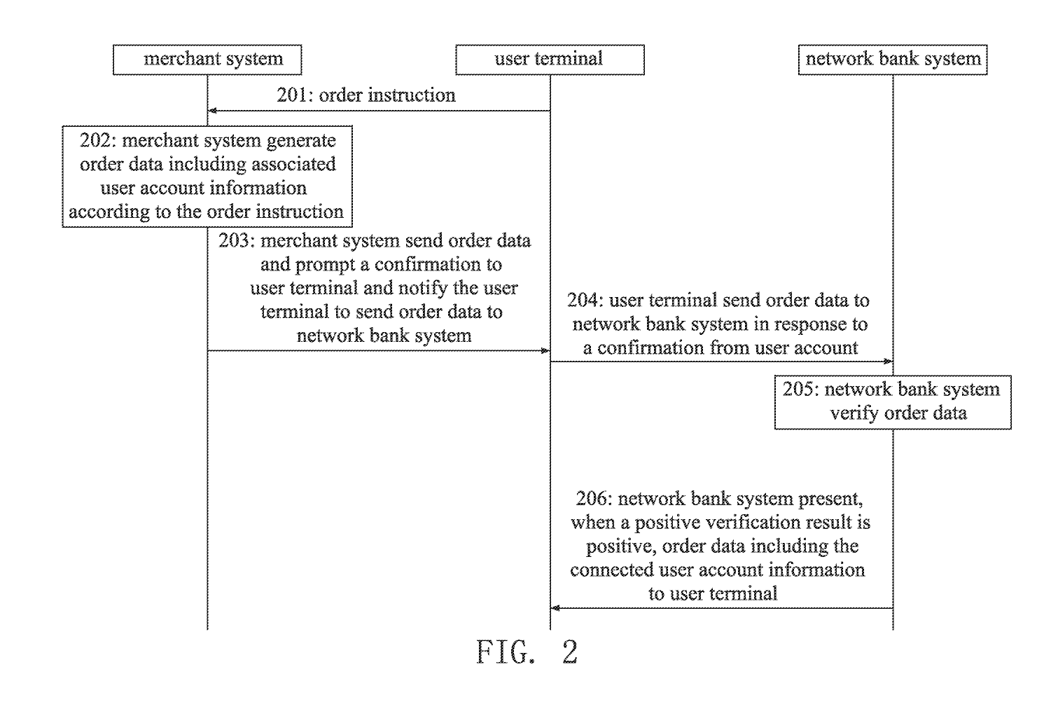

FIG. 2 is a diagram schematically illustrating a processing method for order data in a network payment system in accordance with an embodiment of the present invention. As shown, the processing method in this embodiment includes following steps.

In step 201, a user terminal (e.g., a browser) issues, after a user account selecting a product item through the user terminal and clicking on a purchase button thereon, an order instruction for the product item to a merchant system.

In step 202, the merchant system generates order data including connected user account information according to the order instruction.

Specifically, through an interface of a network bank system, the merchant system generates the order data having a form format according to order product item information of the purchased product item, connected user account information of the purchased product item and merchant information. The order product item information includes specific information such as name and prices of the purchased product item. The connected user account information includes buyer account information connected with this order (that is, the information of the user account submitting this order) and/or seller account information connected with this order.

In step 203, the merchant system sends the order data and prompts a confirmation to the user terminal and notifies the user terminal to send the order data to the network bank system in response to a receiving of a confirmation instruction from the user account.

Specifically, the merchant system performs a signature process on the order data by using an application programming interface (API) of the network bank system and a merchant certification, and returns the web-formatted form to the user terminal (e.g., the browser of the user account). The action address of the form is directed to an application program of the network bank system for receiving order data of merchants; in other words, the user terminal is notified to send the order data to the network bank system through the action address in response to a receiving of the confirmation instruction from the user account.

In step 204, the user terminal sends the order data to the network bank system in response to a receiving of a confirmation instruction from the user account.

In step 205, the network bank system verifies the received order data.

In step 206, the network bank system presents the order data including the connected user account information to the user terminal after the network bank system returning that a corresponding verification result is positive; wherein the order data, including the order product item information of the purchased product item, the connected user account information and the merchant information, etc, herein may be presented in a strong eye-catching manner.

According to the processing method in this embodiment as illustrated in FIG. 2, by presenting connected user account information having a positive verification result to a user terminal, a user account can determine whether the presented user account information is related to the user account himself/herself or not and also determine whether seller account information is related to the purchased product item or not. Thus, even any specified step in this purchasing process is manipulated or forged by malicious programs, the user account can be aware of the issue in the presented information and accordingly stop the payment process timely. Consequentially, the information of the money count associated with the user account is prevented from being stolen indirectly and the data security of the network payment system is increased.

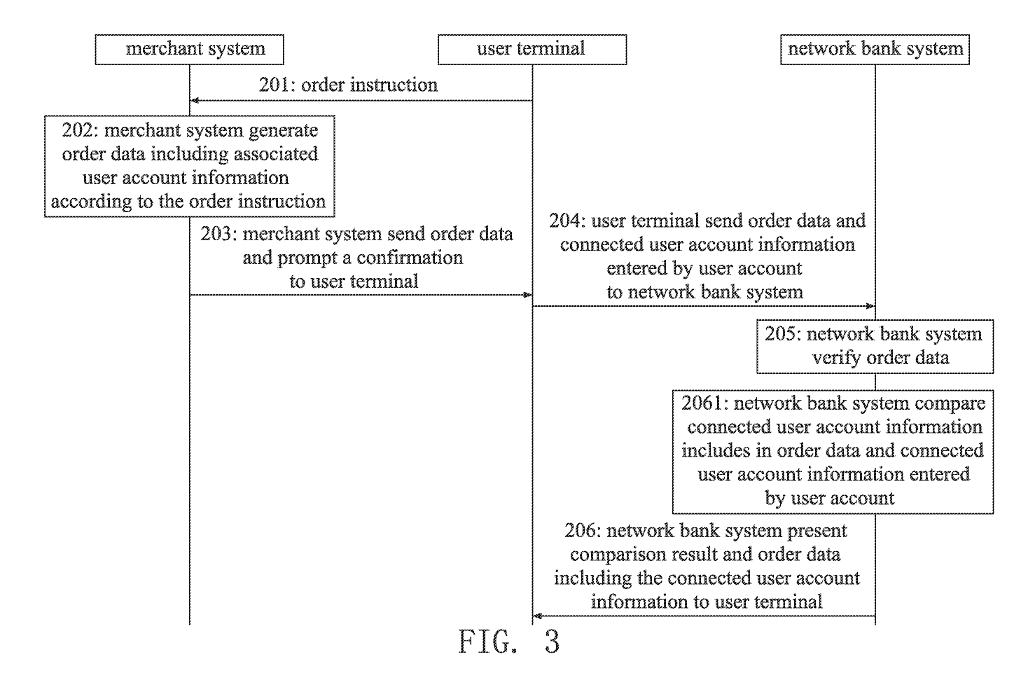

FIG. 3 is a diagram schematically illustrating a processing method for order data in a network payment system in accordance with another embodiment of the present invention. As shown, the processing method in this embodiment includes following steps.

In step 203, the merchant system further prompts the user account to enter the connected user account information. In step 204, the user terminal further sends the connected user account information entered by the user account to the network bank system. The connected user account information herein may include the buyer account information connected with this order, the seller account information connected with this order, or both of the buyer account information and seller account information connected with this order; however, it is to be noted that the connected user account information entered by the user account herein has a specific type corresponding to that of the connected user account information generated in Step 202.

In step 2061, after a positive verification result of the order data is obtained, the network bank system compares the connected user account information included in the order data with the connected user account information entered by the user account.

In step 206, the network bank system presents the comparison result, obtained by the aforementioned comparison between the connected user account information included in the order data with the connected user account information entered by the user account, as well as the order data including the connected user account information to the user account.

According to the processing method in this embodiment as illustrated in FIG. 3, if the order data automatically generated by the merchant system is forged by malicious programs at the user terminal, the connected user account information carried in the forged order data in the merchant system is different to the connected user account information entered by the user account. Thus, the user account can be aware of that the order data may be forged timely and consequentially the network payment system has higher data security.

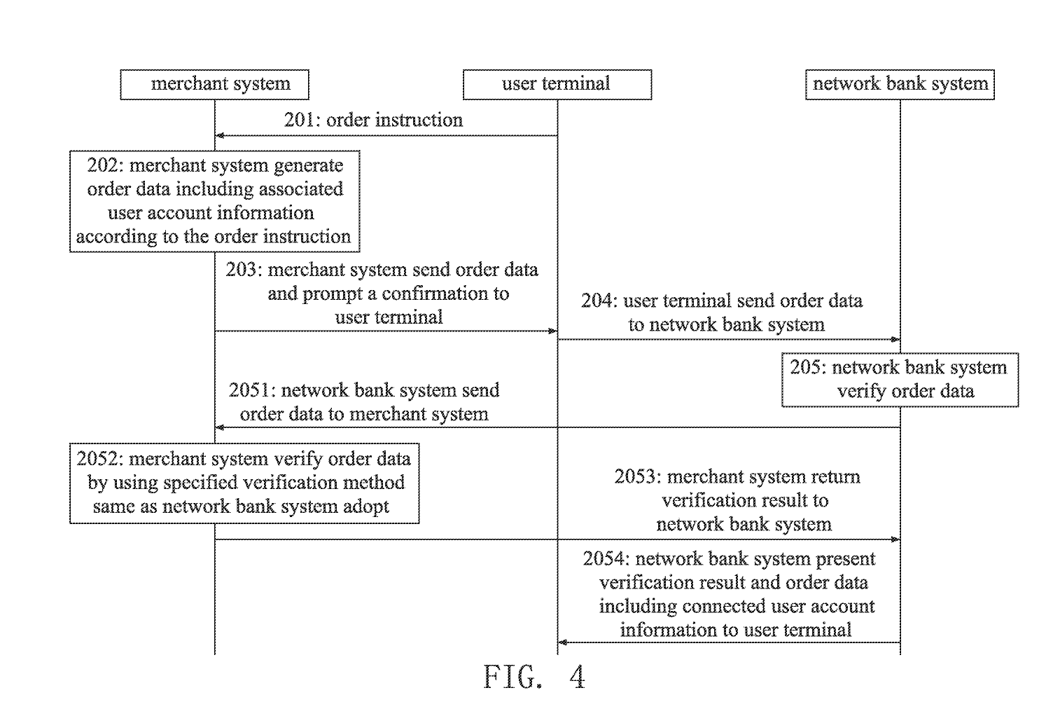

FIG. 4 is a diagram schematically illustrating a processing method for order data in a network payment system in accordance with still another embodiment of the present invention. As shown in FIG. 4, in order to further prevent the security issue resulted by malicious programs, the processing method in this embodiment further includes, after the step of the network bank system returning that the verification result of the order data is positive and before the step of presenting the order data to the user account, following steps.

In step 2051: the network bank system sends the received order data to the merchant system.

In step 2052, the merchant system verifies, after receiving the order data, the order data by using a specified verification method same as the network bank system adopts.

In step 2053, the merchant system returns a corresponding verification result to the network bank system.

In step 2054, the network bank system presents, after the corresponding verification result is received, the corresponding verification result as well as the order data including the connected user account information to the user account.

It is understood that the embodiments illustrated in FIGS. 3, 4 may be combined together. That is, in the embodiment illustrated in FIG. 4, Step 203 may further include: the merchant system further prompting the user account to enter the connected user account information and sending the connected user account information entered by the user account to the network bank system; the network bank system comparing, after a positive verification result of the order data is obtained, the connected user account information included in the order data with the connected user account information entered by the user account and presenting the comparison result to the user account.

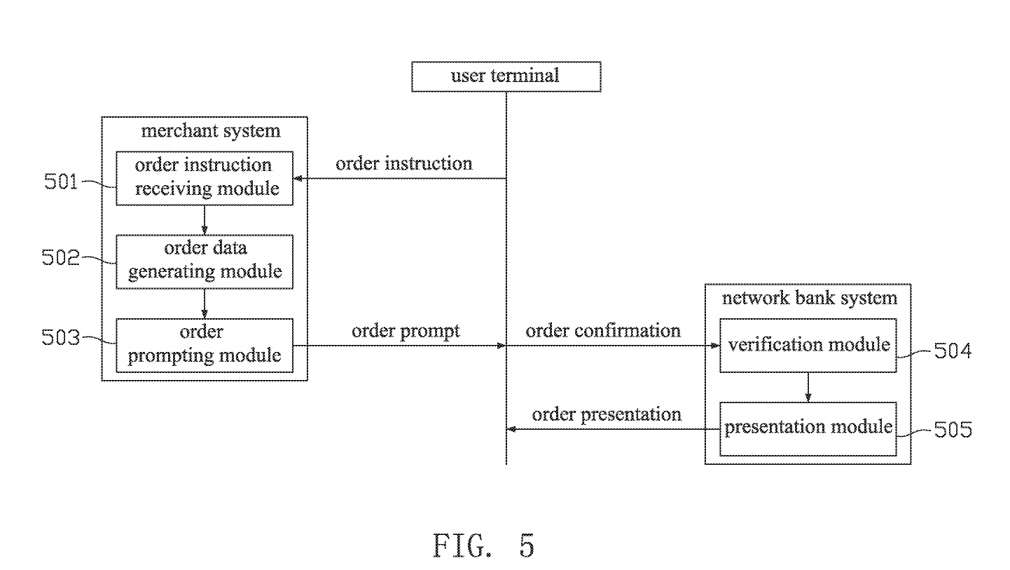

FIG. 5 is a schematic diagram of a processing system for order data in a network payment system in accordance with an embodiment of the present invention. As shown, the processing system in this embodiment includes an order instruction receiving module 501, an order data generating module 502, an order prompting module 503, a verification module 504 and a presentation module 505.

Specifically, the order instruction receiving module 501 is disposed in a merchant system and configured to receive an order instruction issued from a user terminal.

The order data generating module 502 is disposed in the merchant system and configured to generate order data including connected user account information according to the order instruction. The connected user account information includes buyer account information connected with this order and/or seller account information connected with this order.

The order prompting module 503 is disposed in the merchant system and configured to send the order data and prompt a confirmation to the user terminal and notify the user terminal to send the order data to a network bank system in response to a receiving of a confirmation instruction from the user account.

The verification module 504 is disposed in the network bank system and configured to verify the received order data.

The presentation module 505 is disposed in the network bank system and configured to, when a verification result obtained by verifying the received order data is positive, present the order data including the connected user account information to the user terminal.

According to the processing system in this embodiment as illustrated in FIG. 5, by presenting connected user account information having a positive verification result to a user terminal, a user account can determine whether the presented user account information is related to the user account himself/herself or not and also determine whether seller account information is related to the purchased product item or not. Thus, even any specified step in this purchasing process is manipulated or forged by malicious programs, the user account can be aware of the issue in the presented information and accordingly stop the payment process timely. Consequentially, the information of the money count associated with the user account is prevented from being stolen indirectly and the data security of the network payment system is increased.

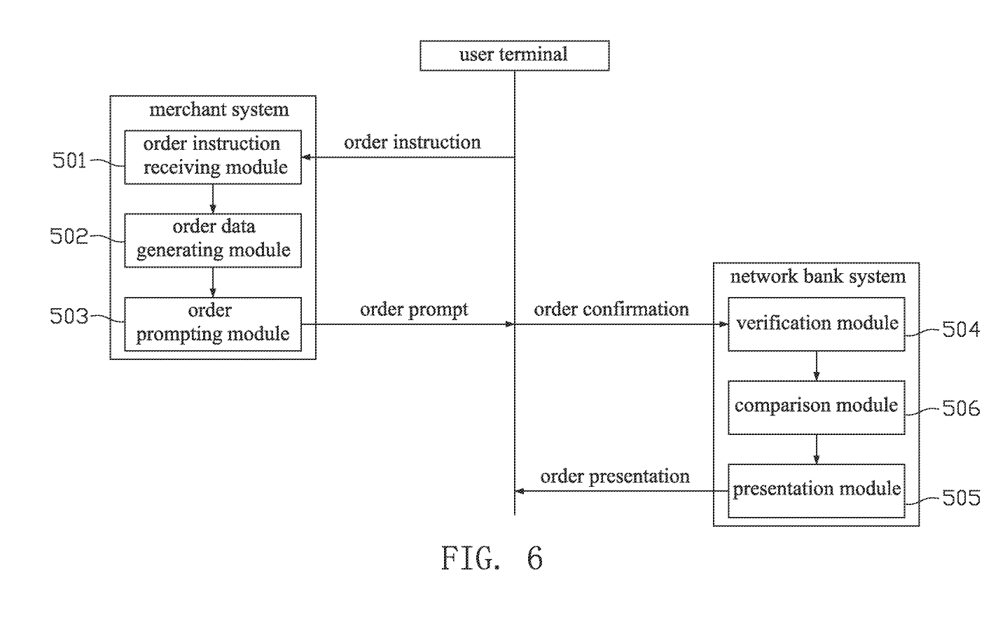

FIG. 6 is a schematic diagram of a processing system for order data in a network payment system in accordance with another embodiment of the present invention. In this embodiment as shown in FIG. 6, the order prompting module 503 is further configured to notify the user terminal to prompt the user account to enter the connected user account information and send the connected user account information entered by the user account to the network bank system. In addition, the processing system in this embodiment further includes a comparison module 506, which is disposed in the network bank system and configured to, when the verification result obtained by verifying the order data is positive, compare the connected user account information included in the order data with the connected user account information entered by the user account and send a corresponding comparison result to the presentation module 505 for being presented to the user account.

According to the processing system in this embodiment as illustrated in FIG. 6, if the order data automatically generated by the merchant system is forged by malicious programs at the user terminal, the connected user account information carried in the forged order data in the merchant system is different to the connected user account information entered by the user account. Thus, the user account can be aware of that the order data may be forged timely and consequentially the network payment system has higher data security.

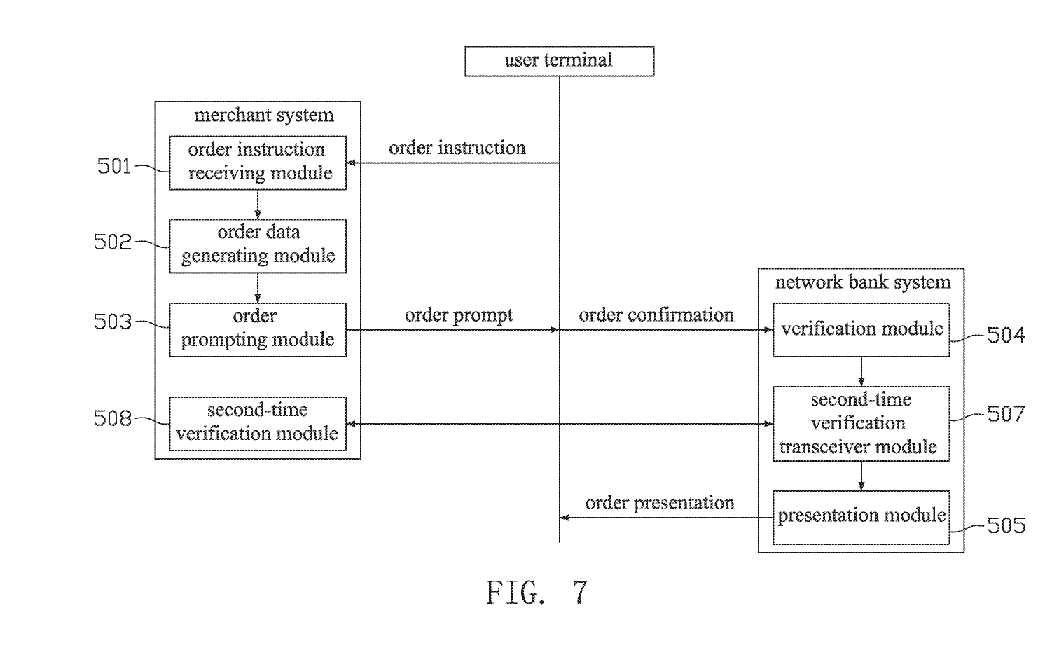

FIG. 7 is a schematic diagram of a processing system for order data in a network payment system in accordance with still another embodiment of the present invention. As shown, the processing system in this embodiment further includes a second-time verification transceiver module 507 and a second-time verification module 508.

Specifically, the second-time verification transceiver module 507 is disposed in the network bank system and configured to send the received order data to the merchant system for a second-time verification when the verification module returns that the corresponding verification result of the order data is positive, receive the second-time verification result returned from the merchant system, and send the second-time verification result to the presentation module 505 for being presented to the user terminal.

The second-time verification module 508 is disposed in the merchant system and configured to perform a second-time verification on the order data sent from the network bank system by using a specified verification method same as the network bank system adopts, and return the second-time verification result to the network bank system.

According to the processing system in this embodiment as illustrated in FIG. 7, the cross-verification on the order data between the merchant system and the network bank system is realized. Thus, the occurrence of the security issue resulted by malicious programs can be prevented fundamentally.

In addition, it is understood that the two embodiments illustrated in FIGS. 6, 7 may be combined together. For example, the embodiment illustrated in FIG. 7 may also include the comparison module 506. Thus, the network payment system has enhanced security.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

### INDUSTRIAL APPLICATION

The present invention has enhanced information connection among merchant system, network bank system and user account as well as improved information presentation of connected to the order by adding the verification and presentation of connected user account information in the process for order data. Thus, even any specified step in this purchasing process is manipulated or forged by malicious programs, the user account can be aware of the issue in the presented information and accordingly stop the payment process timely. Consequentially, the information of the money count associated with the user account is prevented from being stolen indirectly and the data security of the network payment system is increased.

What is claimed is:

1. A processing method for order data in a network payment system, the processing method comprising:
receiving an order instruction issued from a user terminal;
generating an order data including a connected user account information according to the order instruction;
sending the order data and prompting a confirmation to the user terminal and notifying the user terminal to send the order data to a network bank system in response to a receiving of a confirmation instruction from a user account and thereby configuring the network bank system to verify the order data; and
presenting the order data including the connected user account information to the user terminal after the network bank system returning that a corresponding verification result is positive.

2. The processing method according to claim 1, wherein:
the step of sending the order data and prompting a confirmation to the user terminal and notifying the user terminal to send the order data to a network bank system in response to a receiving of a confirmation instruction from a user account and thereby configuring the network bank system to verify the order data further comprises: prompting the user account to enter the connected user account information and sending the connected user account information entered by the user account to the network bank system;
wherein the step of presenting the order data including the connected user account information to the user terminal after the network bank system returning that a corresponding verification result is positive further comprises: comparing, when the verification result obtained by verifying the order data is positive, the connected user account information included in the order data with the connected user account information entered by the user account and presenting a corresponding comparison result to the user account.

3. The processing method according to claim 1, wherein the step of presenting the order data including the connected user account information to the user terminal after the network bank system returning that a corresponding verification result is positive further comprises:
sending, by the network bank system, the received order data to the merchant system;
verifying, by the merchant system and after the order data is received, the order data by using a verification method same as the network bank system adopts and returning a corresponding verification result to the network bank system; and
presenting, by the network bank system and after the corresponding verification result is received, the corresponding verification result to the user account.

4. The processing method according to claim 1, wherein the connected user account information comprises a connected buyer account information and/or a connected seller account information.

5. A processing system for order data in a network payment system, the processing system comprising:
an order instruction receiving module disposed in a merchant system and configured to receive an order instruction issued from a user terminal;
an order data generating module disposed in the merchant system and configured to generate an order data including a connected user account information according to the order instruction;
an order prompting module disposed in the merchant system and configured to send the order data and prompt a confirmation to the user terminal and notify the user terminal to send the order data to a network bank system in response to a receiving of a confirmation instruction from the user account;
a verification module disposed in the network bank system and configured to verify the received order data; and
a presentation module disposed in the network bank system and configured to, when a verification result obtained by verifying the received order data is positive, present the order data comprising the connected user account information to the user terminal.

6. The processing system according to claim 5, wherein:
the order prompting module is further configured to notify the user terminal to prompt the user account to enter the connected user account information and send the connected user account information entered by the user account to the network bank system;
wherein the processing system further comprises a comparison module disposed in the network bank system and configured to, when the verification result obtained by verifying the order data is positive, compare the connected user account information included in the order data with the connected user account information entered by the user account and send a corresponding comparison result to the presentation module for being presented to the user account.

7. The processing system according to claim 5, further comprising:
a second-time verification transceiver module disposed in the network bank system and configured to send the received order data to the merchant system for a second-time verification when the verification module returns that the corresponding verification result of the order data is positive, receive a second-time verification result returned from the merchant system, and send the second-time verification result to the presentation module for being presented to the user terminal; and
a second-time verification module disposed in the merchant system and configured to perform the second-time verification on the order data sent from the network bank system by using a verification method same as the network bank system adopts, and return the second-time verification result to the network bank system.

8. The processing system according to claim 5, wherein the connected user account information comprises a connected buyer account information and/or a connected seller account information.
